(19) United States
(12) Patent Application Publication
(10) Pub. No.: US 2023/0222899 A1
(43) Pub. Date: Jul. 13, 2023

(54) SYSTEM FOR TRACKING AND REPORTING TOLL ROAD USAGE IN REAL TIME

(71) Applicant: Jacob Thomas, Austin, TX (US)

(72) Inventor: Jacob Thomas, Austin, TX (US)

(21) Appl. No.: 18/096,210

(22) Filed: Jan. 12, 2023

Related U.S. Application Data
(60) Provisional application No. 63/299,250, filed on Jan. 13, 2022.

(51) Int. Cl. G08G 1/01; G06K 7/10; G08G 1/04; G08G 1/052; G07C 5/02

(52) U.S. Cl. CPC G08G 1/0129; G06K 7/10366; G08G 1/04; G08G 1/0112; G08G 1/052; G07C 5/02

(57) ABSTRACT

The system for tracking and reporting toll road usage in real time disclosed herein may track tolling points, tolling segments, and toll assessments across multiple technologies to provide a single system that may be used universally. The system for tracking and reporting toll road usage in real time may comprise a plurality of sensors installed in a vehicle, or in a standalone module that may be installed in a vehicle, in combination with a central database for aggregating and processing the sensed information. The various sensors may include, for example, GPS-based location devices, RFID transponders and detectors, short-range wireless technology devices, inertial measurement devices, occupancy sensors, cameras, and lost mode trackers.

### TECHNICAL FIELD OF THE INVENTION

The present invention relates in general to toll readers, and, more specifically, to a system for tracking and reporting toll road usage in real time.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A toll road is a public or private road that may be traversed in exchange for a fee; the fee being assessed usually to maintain the road or limit its access. Toll roads are in wide use around the country, and the method of paying the toll for using the road varies broadly. Historically a toll booth or toll gate would be installed where a user can stop and pay the appropriate toll fees. More modernly, though, and to reduce congestion, toll roads implement electronic mechanisms for billing and receiving toll payments automatically.

Some mechanisms for automatic tolling involve the use of radio-frequency identification (RFID) tags, number-plate recognition, GPS-based geofencing, and the use of smartphone applications. All of these mechanisms provide various advantages but also comprise inherent limitations. RFID tags. for example, must be installed within a vehicle to work and, even once installed, may not be read properly due to electronic interferences outside of or within the vehicle itself. Number-plate recognition involves video cameras that must read a vehicle's license plate as it drives by at speed, but the process involves significant backend processing and is prone to errors if the license plate is installed incorrectly or blocked from view. GPS-based geofencing necessarily requires GPS reception to work, and may lead to issues where tolled and non-tolled lanes run adjacent to each other. Even the use of software applications requires that the smartphone be turned on and often requires the user to manually confirm a toll transaction.

Further compounding these various limitations is the issue that different toll authorities across the country may utilize different automatic tolling systems. This use of different technologies becomes especially onerous when a user is travelling across multiple states or the country, and their particular automatic tolling system is not compatible with the various authorities they come across. Rental car fleets, for example, are especially prone to this issue as the cars in these fleets tend to travel significant distances and may traverse toll roads controlled by multiple different authorities. If the rental car owner is not timely notified of the toll applied to a particular vehicle, this toll and any related fees may be difficult to reacquire from the user of the vehicle itself.

Thus, there is a need in the art for a system for tracking and reporting toll road usage in real time that may track tolling points, tolling segments, and toll assessments across multiple technologies to provide a single system that may be used universally. The system for tracking and reporting toll road usage in real time may comprise a plurality of sensors installed in a vehicle, or in a standalone module that may be installed in a vehicle, in combination with a central database for aggregating and processing the sensed information. The various sensors may include, for example, GPS-based location devices, RFID transponders and detectors, short-range wireless technology devices, inertial measurement devices, occupancy sensors, cameras, and lost mode trackers. It is to these ends that the present invention has been developed.

### BRIEF SUMMARY OF THE INVENTION

To minimize the limitations in the prior art, and to minimize other limitations that will be apparent upon reading and understanding the present specification, the present invention describes a system for tracking and reporting toll road usage in real time.

It is an objective of the present invention to provide a system for tracking and reporting toll road usage in real time that may comprise a toll tracker module.

It is another objective of the present invention to provide a system for tracking and reporting toll road usage in real time that may comprise a standalone device.

It is another objective of the present invention to provide a system for tracking and reporting toll road usage in real time that may comprise a GPS device.

It is another objective of the present invention to provide a system for tracking and reporting toll road usage in real time that may comprise a radio frequency detector.

It is another objective of the present invention to provide a system for tracking and reporting toll road usage in real time that may comprise an RFID transponder.

It is another objective of the present invention to provide a system for tracking and reporting toll road usage in real time that may comprise an RF sensor.

It is another objective of the present invention to provide a system for tracking and reporting toll road usage in real time that may comprise a short-range wireless technology device.

It is another objective of the present invention to provide a system for tracking and reporting toll road usage in real time that may comprise a near-field communication (NFC) device.

It is another objective of the present invention to provide a system for tracking and reporting toll road usage in real time that may comprise an inertial measurement device.

It is another objective of the present invention to provide a system for tracking and reporting toll road usage in real time that may comprise an occupancy sensor.

It is another objective of the present invention to provide a system for tracking and reporting toll road usage in real time that may comprise a camera.

It is another objective of the present invention to provide a system for tracking and reporting toll road usage in real time that may comprise a lost mode tracker.

It is another objective of the present invention to provide a system for tracking and reporting toll road usage in real time that may comprise a paper mile tracker.

It is another objective of the present invention to provide a system for tracking and reporting toll road usage in real time that may comprise a plurality of sensors.

It is another objective of the present invention to provide a system for tracking and reporting toll road usage in real time that may comprise a central database.

It is another objective of the present invention to provide a system for tracking and reporting toll road usage in real time that may comprise a resilient material of construction.

It is another objective of the present invention to provide a system for tracking and reporting toll road usage in real time that may comprise a water-proof material of construction.

It is another objective of the present invention to provide a system for tracking and reporting toll road usage in real time that may comprise a reusable material of construction.

It is another objective of the present invention to provide a system for tracking and reporting toll road usage in real time that may comprise an antimicrobial layer.

It is another objective of the present invention to provide a system for tracking and reporting toll road usage in real time that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 schematically presents a toll tracker module and its various components of a system for tracking and reporting toll road usage in real time, as contemplated by the present disclosure;

FIG. 2 schematically presents an event detection using RF signals of a system for tracking and reporting toll road usage in real time, as contemplated by the present disclosure;

FIG. 3 schematically presents an event detection using cameras of a system for tracking and reporting toll road usage in real time, as contemplated by the present disclosure;

FIG. 4 schematically presents an event detection using RF signals and cameras of a system for tracking and reporting toll road usage in real time, as contemplated by the present disclosure;

FIG. 5 schematically presents a server-side processing of events of a system for tracking and reporting toll road usage in real time, as contemplated by the present disclosure;

FIG. 6 schematically presents an occupancy detection using occupancy detection sensors of a system for tracking and reporting toll road usage in real time, as contemplated by the present disclosure; and

FIG. 7 schematically presents a user detection using NFC signals of a system for tracking and reporting toll road usage in real time, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The system for tracking and reporting toll road usage in real time disclosed herein may track tolling points, tolling segments, and toll assessments across multiple technologies to provide a single system that may be used universally. The system for tracking and reporting toll road usage in real time may comprise a plurality of sensors installed in a vehicle, or in a standalone module that may be installed in a vehicle, in combination with a central database for aggregating and processing the sensed information. The various sensors may include, for example, GPS-based location devices, RFID transponders and detectors, short-range wireless technology devices, inertial measurement devices, occupancy sensors, cameras, and lost mode trackers.

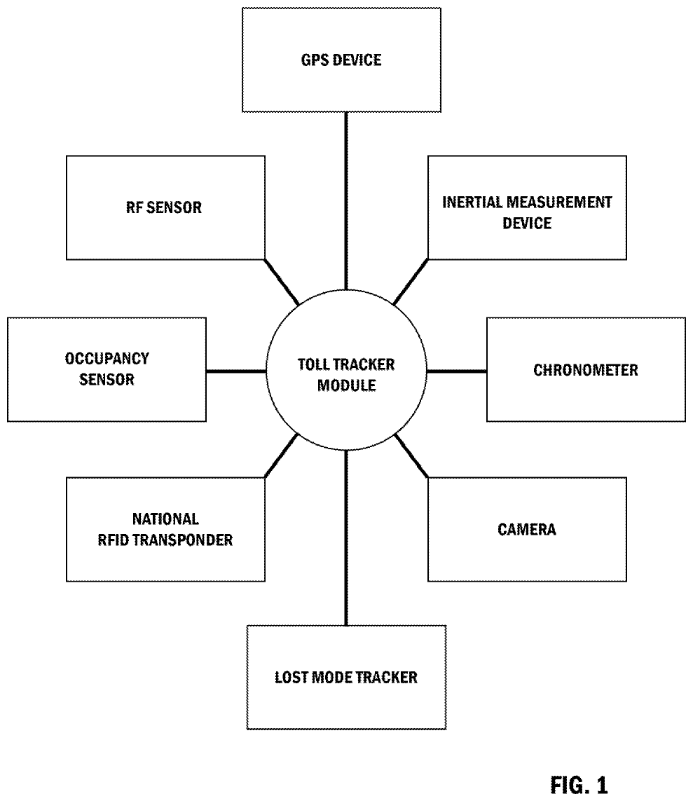

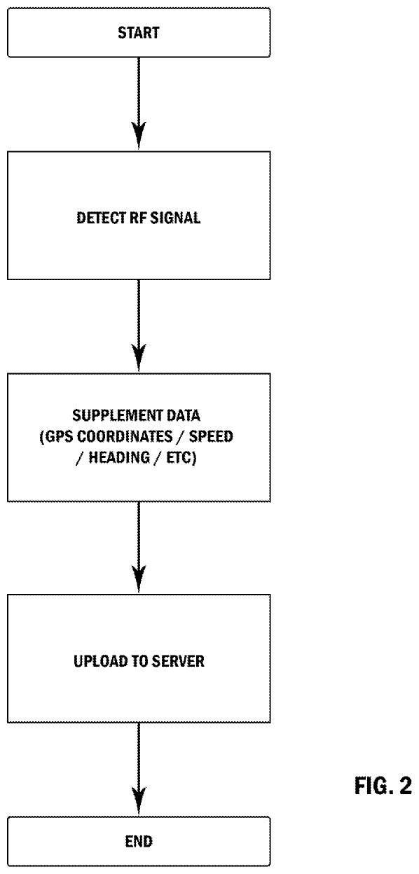

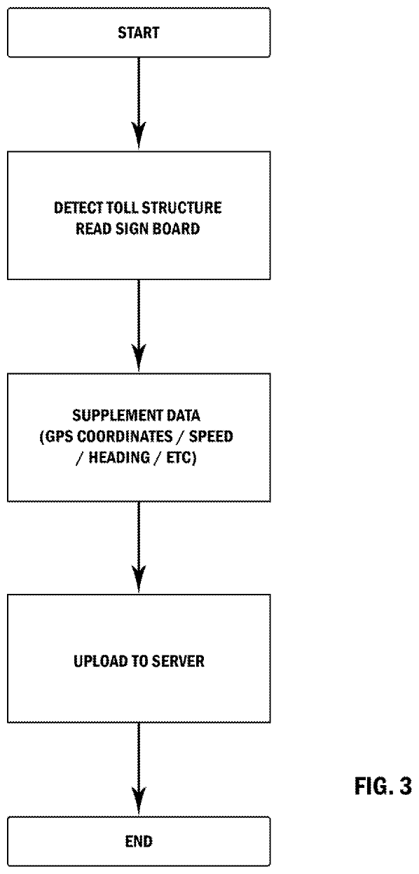

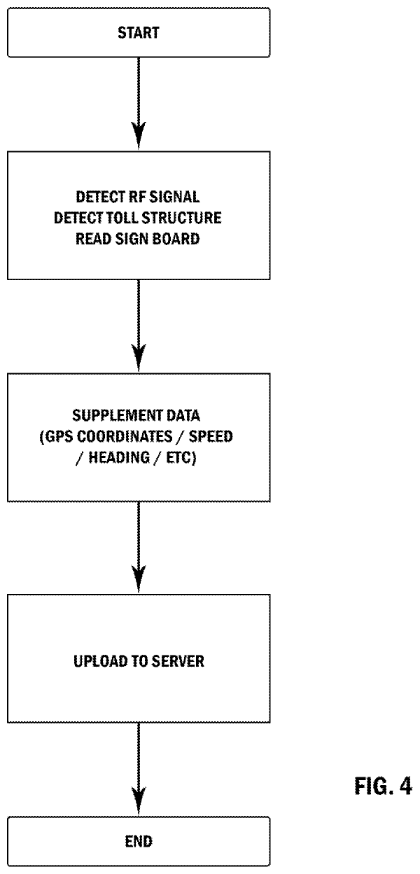

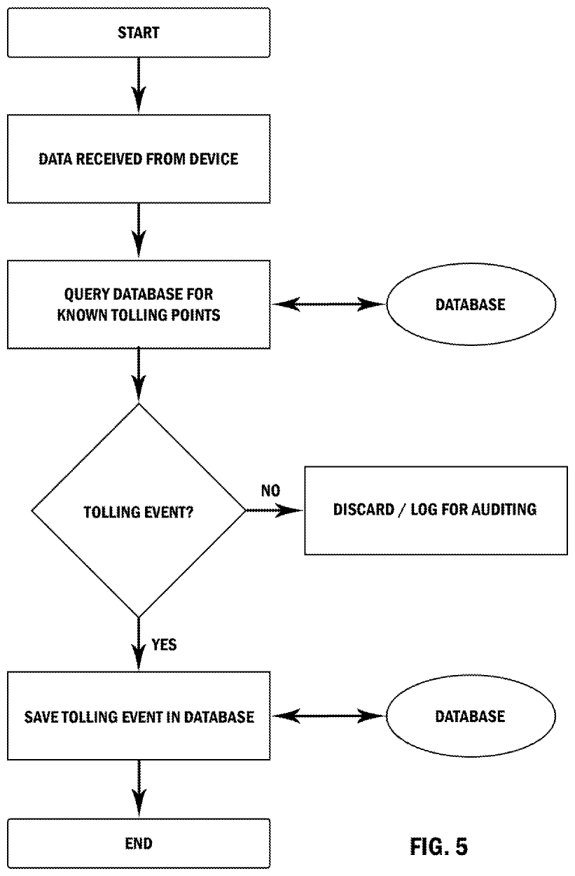

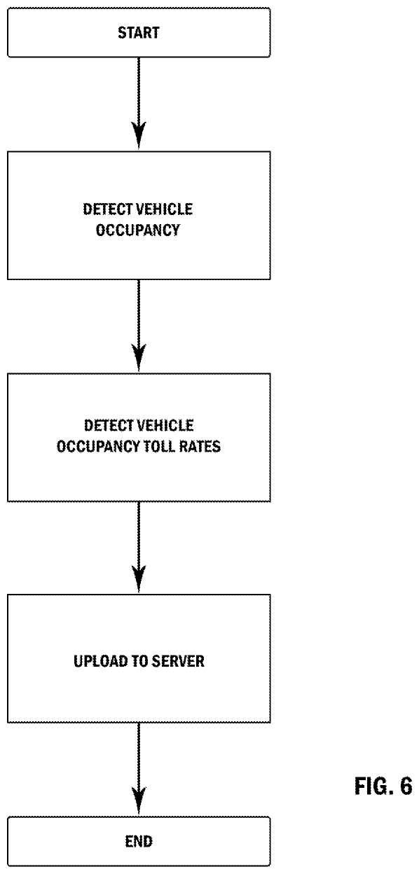

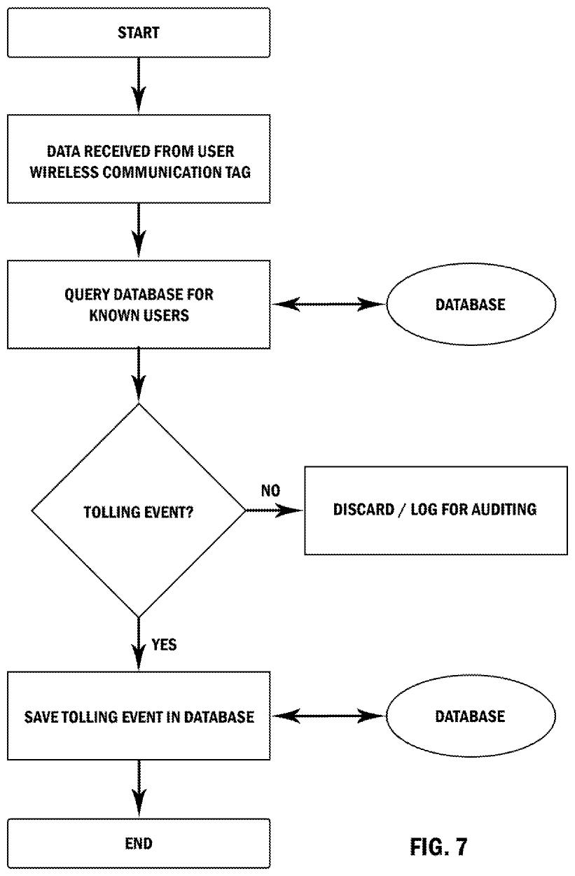

The illustrations of FIGS. 1-7 illustrate a system for tracking and reporting toll road usage in real time, as contemplated by the present disclosure. The device may comprise, generally, a toll tracker device that may be built into a vehicle or may further comprise a standalone module that may be installed into a vehicle. The toll tracker device may comprise any combination of a plurality of sensors such as, for example, a GPS device, an RF sensor, an RFID detector, an RFID transponder, an inertial measurement device, a plurality of cameras, and a lost mode tracker.

The majority of toll roads comprise a toll gantry, which is usually a system of signs and RFID readers installed on or around the roadway. The signs themselves inform drivers that they are on or entering a toll road and makes these drivers aware of the costs of the toll to be incurred. The RFID readers then read an RFID transponder installed in the driver's vehicle, and automatically charge or bill the vehicle or its owner for the amount of the toll. For this reason, the system for tracking and reporting toll road usage in real time may comprise one or more RFID transponders so that the system may be queried by and may respond to toll readers in the gantry.

The system may further comprise an RF sensor, which may also detect when the vehicle is being queried, but instead of responding to the query may only record the query within the system and activate the plurality of sensors connected to the system. In this way the system for tracking and reporting toll road usage in real time may only be active when the vehicle is being driven on a toll road, as determined by the RF sensor being triggered by a toll road gantry or other device. The RF sensor may further be able to distinguish individual toll gantries and tolling systems based on the RFID frequencies used by the various third-party devices. The RF sensor may further be able to determine the frequency and the power level of RF signals that are being transmitted by a toll road gantry or other device.

Other toll roads may comprise tolling segments, wherein a plurality of gantries or other sensors are implemented to determine what percentage of the total length of toll road has been used by a user so that the user may be charged a fee appropriate to the actual distance utilized. For this reason, the system for tracking and reporting toll road usage in real time may further comprise one or more GPS devices so that the system may determine the location of the vehicle and record such data concurrently with data from the RFID transponders and the remainder of the system.

To enhance the accuracy of the GPS device the system for tracking and reporting toll road usage in real time may further comprise differential GPS (DGPS), satellite based augmentation systems (SBAS), real-time kinematic (RTK) positioning, and other similar technologies. DGPS can supplement and enhance the positional data available from GPS and can increase accuracy by about a thousandfold, from approximately 15 meters to 1 to 3 centimeters. SBAS improves the accuracy and reliability of GPS information by correcting signal measurement errors and by providing information about the accuracy, integrity, continuity, and availability of its signals. RTK is the application of surveying to correct for common errors in current GPS systems.

An inertial measurement device is an electronic device that measures and reports the specific forces, including angular momentum and orientation, of a vehicle in which it may be installed. Such a device can provide additional data in addition to the GPS location to more accurately report the location of a vehicle, compute the amount of time the vehicle is on a toll road, or record the speed and direction of travel of a vehicle. The inertial measurement device may implement accelerometry principles and may also provide data on the position and location of a vehicle when a GPS signal is not available.

One or more cameras may be used by the system for tracking and reporting toll road usage in real time to confirm a vehicle's location on a roadway, such as in a toll lane as opposed to a parallel non-tolled lane, or may be used to confirm the pricing of a toll as displayed on a toll gantry. The cameras may be able to read a static toll sign, where the price is continuously fixed, or a dynamic or electronic toll sign, where the price changes based on demand for the toll road. The cameras may further be able to determine changes in toll prices and road conditions, such as the closure or addition of exits, and relay this information to the central database where such information may be automatically or manually updated.

One or more chronometers may be used by the system for tracking and reporting toll road usage in real time to confirm the time, both actual and relative, that a vehicle is being queried by various tolling systems, or may be used to confirm the pricing of a toll at a particular time of the day. The chronometers may implement chronometry principles and may be able to relate to the system the current date and time that the vehicle is being driven, as well as the amount of time the vehicle is driving in a toll lane based on the amount of time the vehicle is being queried by the tolling system.

The system for tracking and reporting toll road usage in real time may further comprise a lost mode tracker that may be used to locate and identify a missing vehicle. Such a device may combine data from the GPS device, inertial measurement device, and chronometer of the system to determine a current or last-known location for a vehicle, and may be especially valuable to owners of rental or fleet vehicles, ridesharing services, fleet operators, trucking companies, and individual truck drivers.

In one embodiment the system for tracking and reporting toll road usage in real time may comprise a customer privacy setting. Many tracking systems known in the art may record where a vehicle began and ended its travels, or where a vehicle is currently located, and then may infer from the recorded data whether or not the vehicle crossed a toll road. By contrast, the system herein may record all of the various data points associated with the sensors of a particular embodiment only when the system is queried by a tolling system so that the route of travel of a user is not recorded or known to the system. Some users, such as trucking companies or rental car companies may wish to disable such a feature for their own security. If the lost mode tracker of the device is activated this may also override the customer privacy setting of the system.

The system for tracking and reporting toll road usage in real time may further comprise a driver identification system that identifies an individual user that is driving the vehicle during the recording of the various data points associated with the sensors of a particular embodiment. In this way rental car companies may be able to associate toll fees with a particular vehicle renter, or fleet operators may be able to associate toll fees with a particular driver to more accurately determine how the fees should be allocated by the end user. The driver identification system may comprise an RFID device, a near-field communication (NFC) device, or a short-range wireless technology device (such as, for example, a Bluetooth device) that recognizes a user's phone, RFID tag, or other similar component.

The system for tracking and reporting toll road usage in real time may further comprise a central database that is wirelessly connected to the vehicle to receive, send, and compile data sent from the vehicle. The vehicle may send a plurality of data to the central database such as, for example, the fact that it has detected a radio frequency signal from a toll gantry, the vehicle's GPS location, speed, and direction, the vehicle's inertial measurement location, speed, and direction, any camera inputs recorded, and any data inferred from the camera inputs. The central database may compile this data to determine if the vehicle is travelling on a toll road, determine what the toll for that vehicle is, and compile that toll information into the vehicle's records. The central database may then report the vehicle's toll records to the vehicle owner, the vehicle driver, a ridesharing service, or a toll authority as desired.

In one embodiment of the system for tracking and reporting toll road usage in real time the toll tracker device may comprise an RF sensor, a GPS device, an inertial measurement device, and a radio frequency detector. In another embodiment the toll tracker device may further comprise a plurality of cameras. In yet another embodiment the toll tracker device may further comprise a lost mode tracking device. The toll tracker device may be built into new vehicles as they are manufactured, or may comprise a standalone device that may be installed into an already-manufactured vehicle.

Some toll roads comprise high-occupancy toll roads, which are roads that may be traversed without fee by vehicles with sufficient occupancy while vehicles with insufficient occupancy must pay the toll. In one embodiment the system for tracking and reporting toll road usage in real time may further comprise an occupancy sensor, which may be a plurality of pressure sensors, thermal imaging sensors, or any other appropriate sensor, to determine how many persons are within the vehicle. In one embodiment the toll tracker device may further comprise a high occupancy sensor that tracks how many phones are in a car.

In one embodiment the system for tracking and reporting toll road usage in real time may further comprise an antenna and appropriate antenna shielding. The antenna may be used to communicate wirelessly with a toll gantry, radio frequency detector, or the central database. The antenna may be shielded on its sides and from below to prevent interference with other electrical or radio signals around the system. Leaving the antenna shielding open from the top allows the system to still communicate with toll gantries and other appropriate systems.

In one embodiment the system for tracking and reporting toll road usage in real time may further comprise an audiovisual component, such as a plurality of speakers or lights or a display screen, that may provide an audible or visual cue to a driver of a vehicle. The audible or visual cue may serve any appropriate purpose such as, for example, informing the driver that they are about to enter or are occupying a toll road, the amount of the toll being incurred, or the total toll balance for the vehicle.

In one embodiment the system for tracking and reporting toll road usage in real time may further comprise an onboard diagnostic tool, which may be a device that plugs into the onboard diagnostics port of a vehicle and can read and report conditions from the plurality of sensors within the vehicle.

To begin using the system for tracking and reporting toll road usage in real time the device may be installed in a vehicle, and the vehicle may approach or traverse a toll road. The toll road authority may implement a system that queries the vehicle, such as an RFID reader, and the system may recognize this query of the vehicle. The system may then aggregate data from the various devices installed within the vehicle such as, for example, the GPS device, the inertial measurement device, the radio frequency sensor, the RFID transponder, the plurality of cameras, and the lost mode tracker, and send this aggregation of data to the central database. The camera may also be used to recognize a tolling point on its own and without the help of the RFID detector.

The central database may then compile the data to determine if the vehicle is on a toll road and what the toll charge is to be, and may then record the toll data and the vehicle's location to the vehicle's records. The central database may further report the compiled toll data and the vehicle's location to the owner of the vehicle. In one embodiment of the system for tracking and reporting toll road usage in real time the lost mode tracking device may only report the location of a vehicle after multiple failed query attempts of the vehicle itself or of the user of the vehicle.

The system for tracking and reporting toll road usage in real time may be substantially constructed of any suitable material or combination of materials, but typically is constructed of a resilient material or combination of materials such that the device is easily manufactured, insulating, and reusable. As an example, and without limiting the scope of the present invention, various exemplary embodiments of the system for tracking and reporting toll road usage in real time may be substantially constructed of one or more materials of plastic, acrylic, polycarbonate, fabric, steel, aluminum, brass, fiberglass, carbon fiber, or combinations thereof. In some embodiments the various components of the device may be coated, lined, or otherwise insulated to prevent contamination of the device.

In one embodiment the system for tracking and reporting toll road usage in real time may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A toll road usage tracking system, comprising:
an RF sensor;
a GPS device;
an inertial measurement device;
a chronometer;
a lost mode tracker;
a system processor;
a wireless communication device;
a central database; and
a plurality of user profiles;
wherein said RF sensor identifies a query from a toll road RFID reader and activates said system processor to retrieve a plurality of data from a plurality of sensors attached to the system;
wherein said GPS device determines a user vehicle's parameters using global positioning telemetry;
wherein said inertial measurement device determines said user vehicle's parameters using accelerometry;
wherein said chronometer determines said user vehicle's parameters using chronometry;
wherein said lost mode tracker determines said user vehicle's parameters using said GPS device, said inertial measurement device, and said chronometer;
wherein said system processor sends said plurality of data from said plurality of sensors attached to the system to said central database via said wireless communication device; and
wherein said central database processes, analyzes, and collates said plurality of data from said plurality of sensors attached to the system into a customer event and associates said customer event to one of said plurality of user profiles.

2. The toll road usage tracking system of claim 1, further comprising:
an RFID transponder;
wherein said RFID transponder receives a query from a toll road RFID reader and responds to said toll road RFID reader.

3. The toll road usage tracking system of claim 1, further comprising:
a plurality of cameras;
wherein said plurality of cameras are installed on said user vehicle;
wherein said plurality of cameras take a plurality of visual inputs.

4. The toll road usage tracking system of claim 1, further comprising:
an NFC device;
wherein said NFC device queries and receives a response from an individual user device;
wherein said response from said individual user device identifies an individual user.

5. The toll road usage tracking system of claim 1, further comprising:
a short-range wireless technology device;
wherein said short-range wireless technology device queries and receives a response from an individual user device;
wherein said response from said individual user device identifies an individual user.

6. The toll road usage tracking system of claim 1, further comprising:
a high occupancy sensor;
wherein said high occupancy sensor queries and receives a response from a plurality of passengers.

7. The toll road usage tracking system of claim 1, further comprising:
a privacy setting;
wherein said privacy setting temporarily overrides said system processor's access to said plurality of data from said plurality of sensors attached to the system

8. The toll road usage tracking system of claim 1, further comprising:
antenna shielding.

9. The toll road usage tracking system of claim 1, further comprising:
an audiovisual component.

10. The toll road usage tracking system of claim 1,
wherein the toll usage tracking system comprises an OBD2 connector.

11. The toll road usage tracking system of claim 1,
wherein said RF sensor measures an RF frequency and an RF power level.
